(19) United States
(12) Patent Application Publication
(10) Pub. No.: US 2025/0159722 A1
(43) Pub. Date: May 15, 2025

(54) ENHANCEMENT ON SIDELINK IN UNLICENSED BAND

(71) Applicant: Nokia Technologies Oy, Espoo (FI)

(72) Inventors: Torsten WILDSCHEK, Gloucester (GB); Ling YU, Espoo (FI); Nuno Manuel KIILERICH PRATAS, Aalborg (DK); Vinh VAN PHAN, Oulu (FI); Yong LIU, Shanghai (CN); Tao TAO, Shanghai (CN); Naizheng ZHENG, Beijing (CN)

(21) Appl. No.: 18/715,479

(22) PCT Filed: Dec. 13, 2021
(86) PCT No.: PCT/CN2021/137613

§ 371 Date: May 31, 2024

(51) Int. Cl. H04W 74/0808; H04W 74/00; H04W 74/0833

(52) U.S. Cl. CPC H04W 74/0808; H04W 74/002; H04W 74/085

(57) ABSTRACT

Embodiments of the present disclosure relate to methods, devices, apparatuses, and computer readable medium of enhancement on sidelink in unlicensed band. The method comprises: transmitting, at a first device and to a second device, a target transmission via a sidelink channel occupied by applying a contention window of a first contention window size, CWS; receiving, from the second device, a non-acknowledgement feedback for the target transmission; and determining a second CWS to be used for the contention window based on acknowledgement feedbacks and non-acknowledgement feedbacks associated with a plurality of transmissions preceding the target transmission. In this way, both of intra-SL system collisions and inter-system collisions are taken into consideration when a sidelink UE adjusts the CWS. As such, the sidelink UE can determine the CWS not only based on detection of sidelink transmission failure, but also on the evaluation of ACK/NACK feedbacks for various sidelink transmissions.

### FIELD

Embodiments of the present disclosure generally relate to the field of telecommunication and in particular, to devices, methods, apparatus and computer readable storage media of enhancement on sidelink in unlicensed band (SL-U).

### BACKGROUND

In sub-7 GHz unlicensed bands, the new radio (NR) coexistence with other systems (e.g., IEEE 802.11) is ensured via a Listen Before Talk (LBT) channel access mechanism. To pass an LBT check, a UE observes the channel as available for a number of consecutive Clear Channel Assessment (CCA) slots. For example, a duration of these slots may be 9 us in sub-7 GHz unlicensed bands. If a measured power (i.e., the collected energy during a CCA slot) is below a regulatory specified threshold, which may depend on the operating band and the geographical region, the UE may deem the channel as available.

Before initiating a communication (i.e., the UE takes the role of the initiating device), the UE has to acquire the “right” to access the channel for a certain period of time, namely, the Channel Occupancy Time (COT) by applying an “extended” LBT procedure where the channel must be deemed as free for the entire duration of a Contention Window (CW). Such extended LBT procedure is commonly known as channel access Type 1. Typically, a size of the CW (which is also referred to CWS) is not fixed, but can be increased when a non-acknowledgement (NACK) feedback is received. However, in a case where a sidelink system coexists with a Wi-Fi system in unlicensed band, a sidelink transmission failure may be due to intra-system collisions or inter-system collisions. Thus, it is necessary to take the cause of the sidelink transmission failure into account to improve the adjustment of CWS.

### SUMMARY

In general, example embodiments of the present disclosure provide a solution of contention window size (CWS) adjustment for SL-U.

In a first aspect, there is provided a first device. The first device comprises: at least one processor; and at least one memory including computer program codes. The at least one memory and the computer program codes are configured to, with the at least one processor, cause the first device to: transmit, to a second device, a target transmission via a sidelink channel occupied by applying a contention window of a first contention window size, CWS; receive, from the second device, a non-acknowledgement feedback for the target transmission; and determine a second CWS to be used for the contention window based on acknowledgement feedbacks and non-acknowledgement feedbacks for a plurality of transmissions preceding the target transmission.

In a second aspect, there is provided a method. The method comprises: transmitting, at a first device and to a second device, a target transmission via a sidelink channel occupied by applying a contention window of a first contention window size, CWS; receiving, from the second device, a non-acknowledgement feedback for the target transmission; and determining a second CWS to be used for the contention window based on acknowledgement feedbacks and non-acknowledgement feedbacks for a plurality of transmissions preceding the target transmission.

In a third aspect, there is provided a first apparatus. The first apparatus comprises: means for transmitting, to a second apparatus, a target transmission via a sidelink channel occupied by applying a contention window of a first contention window size, CWS; means for receiving, from the second apparatus, a non-acknowledgement feedback for the target transmission; and means for determining a second CWS to be used for the contention window based on acknowledgement feedbacks and non-acknowledgement feedbacks for a plurality of transmissions preceding the target transmission.

In a fourth aspect, there is provided a non-transitory computer readable medium. The non-transitory computer readable medium comprises program instructions for causing an apparatus to perform the method according to the second aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example network environment in which example embodiments of the present disclosure may be implemented;

FIG. 2 illustrates a schematic diagram of the acquisition of a COT according to some example embodiments of the present disclosure;

FIG. 3 shows a signaling chart illustrating a CWS adjustment procedure according to some example embodiments of the present disclosure;

FIG. 4 illustrates a flowchart of an example method 400 implemented at a terminal device according to some example embodiments of the present disclosure;

FIG. 5 illustrates a simplified block diagram of an apparatus that is suitable for implementing example embodiments of the present disclosure; and

FIG. 6 illustrates a block diagram of an example computer readable medium in accordance with example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as NR, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), a further sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), Integrated Access and Backhaul (IAB) node, a relay, a low power node such as a femto, a pico, and so forth, depending on the applied terminology and technology. The network device is allowed to be defined as part of a gNB such as for example in centralized unit/distributed unit (CU/DU) split in which case the network device is defined to be either a gNB-CU or a gNB-DU.

The term “terminal device” refers to any end device that may be capable of wireless communication. By way of example rather than limitation, a terminal device May also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

A CW adjustment mechanism was introduced in Wi-Fi to derive a back-off time to be applied before a Wi-Fi node can perform its transmission. By means of the CW adjustment mechanism, potential collisions between Wi-Fi nodes can be avoided. In the Wi-Fi system, the CW is initially set to a minimum value, CWmin, and is doubled whenever a collision happens or is detected. After a successful transmission without any collision or when a maximum CW value, CWmax, is reached, the CW is reset to CWmin. In other words, the CW size (CWS) is adjusted based on collisions.

In NR-U, a similar principle on CW size (CWS) adjustment is implemented, with a goal of minimizing inter-system collisions in unlicensed bands, i.e., collisions between the NR-U system and the Wi-Fi system. The adopted design principles in NR-U for the CWS adjustment were:
Increase the CWS upon detection of the occurrence of a collision, for example, based on HARQ-ACK/NACK feedbacks;
Reset to the minimum value of the CWS whenever the transmission succeeds, again based on HARQ-ACK/NACK feedback.

In NR-U, SL communications among UEs over PC5 are based on the principle of transmitter (which is also called as a transmitting UE or Tx UE) oriented one-to-many broadcast. NR SL supports all of the cast types including unicast, groupcast or broadcast.

There are two modes of resource allocation (RA) for a SL transmission, referred to as Mode 1 and Mode 2. In Mode 1, resources or grants for transmissions are scheduled by a serving base station (BS), and thus the SL Tx UE operates in RRC_CONNECTED state. This implies that there is almost no intra SL system collision. In Mode 2, the SL Tx UE autonomously selects resources from a resource pool preconfigured by the network. The resource selection in Mode 2 can be based on a simple random selection or a sensing-based selection that includes full sensing or partial sensing for power saving purpose. Mode 2 can be used for Tx UEs in coverage (IC) or out-of-coverage (OoC), in RRC_CONNECTED, RRC_IDLE, or RRC_INACTIVE state without the need of coordination on resource allocation from the BS. However, resources selection collisions from different SL Tx UEs in proximity may happen in Mode 2, especially in high density scenario.

In NR SL unicast and groupcast, HARQ feedback-based SL retransmission is designed such that the SL Tx UE can be aware of the reception status at the SL Rx UEs. The SL Tx UE may then determine whether SL retransmission are needed or not. In addition, NR SL also supports blind retransmission without HARQ feedback. The SL Tx UE may indicate the need of HARQ feedback in 2nd stage of SL Control Information (SCI). For SL groupcast, two options of HARQ feedback are supported:
In SL groupcast HARQ option 1, a SL Rx UE within a range of the SL Tx UE sends HARQ-NACK feedback if it successfully decodes the SCI but fails in decoding the data payload. Otherwise, the SL Rx UE will not transmit any feedback. In this option, the SL Rx UEs sending the HARQ-NACK feedback will use a common/shared physical sidelink shared channel (PSFCH) resource.
In SL groupcast HARQ option 2, a SL Rx UE sends either HARQ-ACK feedback (e.g. if it successfully decodes the PSCCH and PSSCH), or HARQ-NACK feedback (e.g. if it successfully decodes the SCI but fails in decoding the data payload), or no feedback at all (e.g. if it does not detect/decode the SCI). In this option, each of the SL Rx UEs sends its feedback over a dedicate PSFCH resource.

As previously mentioned, the occurrence of a collision is assumed to be detected based on the received HARQ-ACK/NACK feedback, which in turn may trigger the CWS adjustment. In a Wi-Fi system, the CWS adjustment is performed based on the principle that a reception failure is due to collisions with other Wi-Fi nodes, and therefore the CWS adjustment may serve as a distributed channel access load balancing mechanism as there is no central resource coordination in Wi-Fi. In the NR-U system, the CWS adjustment serves primarily as an inter-system channel access load balancing mechanism, for example, between Wi-Fi and NR-U. This is the case, since all NR-U transmissions are controlled by the network and as such there is no need for such a distributed channel access mechanism. In other words, the role of CWS adjustment mechanism in NR-U is mainly for channel coexistence with Wi-Fi.

It is expected that collisions may occur when the SL UEs autonomously select resources from the (pre-) configured resource pool, when operating in SL resource allocation Mode 2. Therefore, when HARQ-NACK is fed back from a SL Rx UE, it is preferable to determine whether this failure of unlicensed band SL (SL-U) transmission is due to a collision within SL-U system or with other unlicensed band users outside of SL-U system (e.g., Wi-Fi). The intra-system SL collisions can be dealt with existing SL mechanisms, while the inter-system collisions can be dealt via the CWS adjustment mechanism. Therefore, in SL-U, there is the need to differentiate between intra and inter system collisions

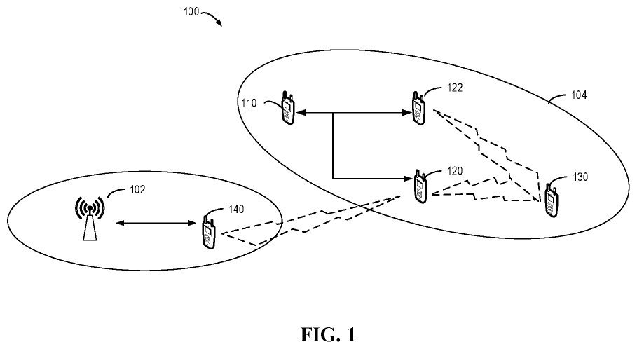

FIG. 1 illustrates an example network environment 100 in which example embodiments of the present disclosure may be implemented. The network environment 100 may include a first device 110, second devices 120 and 122, a third device 130, a fourth device 140 and a network node 102. As shown in FIG. 1, the first device 110, second devices 120 and 122, the third device 130, and the fourth device 140 may be implemented as terminal devices, such as, UE, which may be also referred to as UEs 110 to 140 or the terminal devices 110 to 140 hereinafter. The network node 102 may be implemented as a Wi-Fi node, or any other nodes using a different wireless communication technology in unlicensed band, which may be also referred to as the Wi-Fi node 102 hereinafter.

The first device 110, the second devices 120 and 122, and the third device 130 may communication with each other via a sidelink channel by autonomously selecting resources from a preconfigured resource pool 104. In other words, the first device 110, the second devices 120 and 122, and the third device 130 are in NR SL-U system. The first device 110 may transmit traffic or service to the second devices 120 and 122 in groupcast mode. Additionally, or alternatively, the first device 110 is also able to transmit traffic or service to each of the second devices 120 and 122 in unicast mode.

The fourth device 140 and the network device 102 may communicate based on, e.g., 802.11 protocol. By way of example, the network device 102 is a Wi-Fi node, and the fourth device 140 and the network device 102 are in a Wi-Fi system.

As previously discussed, before initiating any transmission, the device serving as the initiating device needs to acquire the “right” to access the channel for the COT. To do this, a channel access procedure may be performed. Typically, there are two types of channel access procedure, i.e., channel access type 1 with random backoff, and channel access type 2 with one-shot clear channel assessment (CCA).

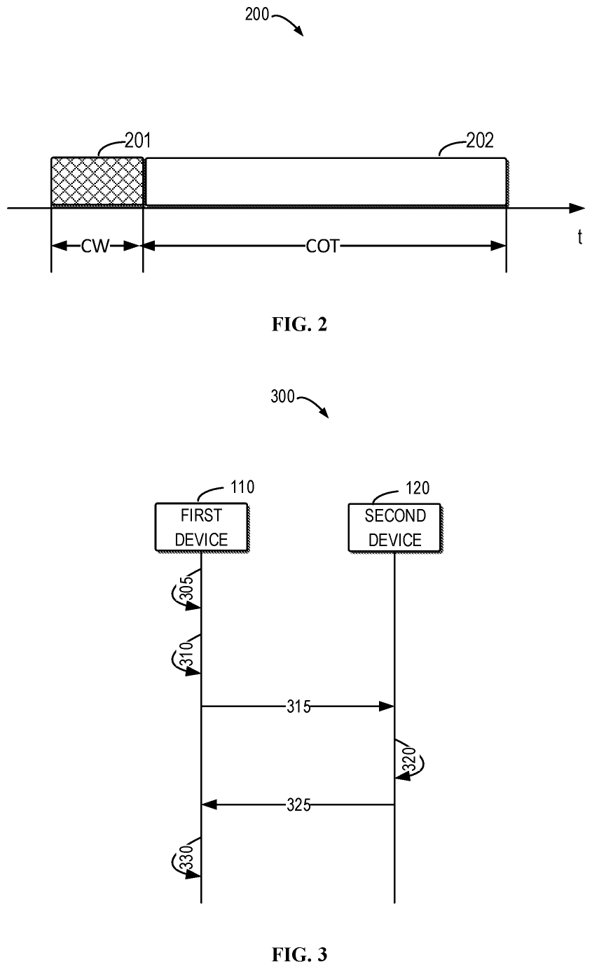

The initiating device may apply the extended LBT procedure, which corresponds to the channel access type 1. FIG. 2 illustrates a schematic diagram of the acquisition of a COT according to some example embodiments of the present disclosure. As shown in FIG. 2, the first device 110 may observe the channel during the CW 201, and if the channel is deemed as free for an entire duration of CW 201, the first device 110 is allowed to access the channel during the COT 202.

As an example, the duration of both the COT and the CW may depend on the Channel Access Priority Class (CAPC) associated with the traffic of the first device 110, as shown in Table 1. Control plane traffic, such as, transmissions on PSCCH, is transmitted with p=1, while user plane traffic is transmitted with p>1. Table 1 shows the channel access Type 1 details for the Uu uplink (UL) case. It should be understood that the channel access Type 1 parameters for the Uu downlink (DL) case could also in principle be adopted in NR SL-U.

TABLE 1
channel access Type 1 parameters for UL case

| Channel Access | | | | | allowed |
|---|---|---|---|---|---|
| Priority Class (p) | mₚ | CW_{min, p} | CW_{max, p} | T_{ulm cot, p} | CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or | (15, 31, 63, 127, |
| | | | | 10 ms | 255, 511, 1023} |
| 4 | 7 | 15 | 1023 | 6 ms or | {15, 31, 63, 127, |
| | | | | 10 ms | 255, 511, 1023} |
| 2 | 2 | 7 | 15 | 4 ms | {7, 15} |

NOTE1:
For p = 3, 4, T_{ulm cot, p} = 10 ms if the higher layer parameter absenceOfAnyOtherTechnology-r14 or absenceOfAnyOtherTechnology-r16 is provided, otherwise, T_{ulm cot, p} = 6 ms.
NOTE 2:
When T_{ulm cot, p} = 6 ms it may be increased to 8 ms by inserting one or more gaps. The minimum duration of a gap shall be 100 us. The maximum duration before including any such gap shall be 6 ms.

In a conventional mechanism of CWS adjustment, e.g., in NR-U, the value of CWS may be increased to a next allowed CWS or reset to the minimum value of CWS depending on detection of HARQ-NACK indicative of transmission failure or HARQ-ACK indicative of successful transmissions. However, the transmission failure in SL-U may due to various reasons and/or different types of collisions.

Referring back to FIG. 1, when the first device 110 transmits traffic to the second devices 120-122, there may be collisions from the third device 130 (i.e., intra-system collusions due to autonomous selection of resources) and collisions from the fourth device 140 (i.e., inter-system collusions). Both types of collisions may lead to the transmission failure at the Rx UEs side. However, the way to deal with these two types of collisions may be different. For example, the intra-system collisions can be dealt with existing SL mechanisms, and the inter-system collisions can be dealt via the CWS adjustment mechanism. According to the example embodiments, the initiating UE may analyze sidelink communication characteristics to differentiate the two types of collisions, and determine whether to adjust and how to adjust the CWS accordingly.

In some example embodiments, the sidelink communication characteristics may be reflected by HARQ-ACK/NACK feedbacks received by the first device 110. By way of example, the first device 110 may transmit SCI on PSCCH to indicate SL resources not only for the current SL transmission but also for SL retransmission and/or future periodic SL transmissions. The reserved resource indication of SL retransmission and future periodic SL transmissions can reduce the rate of intra-system collusions due to full sensing or partial sensing based on the SL mode 2 RA scheme. Therefore, the experienced intra-system collisions for SL initial transmission may be different for SL retransmission or any upcoming periodic SL transmissions within the NR SL-U system. On the other hand, the SCI cannot provide such indications to the UE in the Wi-Fi system, such as, the fourth device 140. Therefore, the experienced inter-system collisions of SL initial transmission may be similar as the inter-system collisions of SL retransmission. The first device 110 may then adjust the CWS depending on the main reason/cause of transmission failure, for example, by increasing or decreasing the CWS, or remaining the CWS unchanged, which will be discussed in details below.

It is to be understood that the number of the devices as shown in FIG. 1 and the duration of CW and COT shown in FIG. 2 are given only for illustrative purpose without suggesting any limitations. For example, the network environment 100 may include any suitable number of terminal devices and network devices adapted for implementing embodiments of the present disclosure. The present disclosure is not limited in these regards.

The communications in the network environment 100 may conform to any suitable standards including, but not limited to, NR, LTE, LTE-evolution, LTE-advanced (LTE-A), wideband code division multiple access (WCDMA), code division multiple access (CDMA) and global system for mobile communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), a future sixth generation (6G) and/or any further communication protocols.

Principle and implementations of the present disclosure will be described in detail below with reference to FIG. 3. FIG. 3 shows a signaling chart illustrating a CWS adjustment procedure 300 according to some example embodiments of the present disclosure. For the purpose of discussion, the process 300 will be described with reference to FIG. 1. The process 300 may involve the first device 110, the second devices 120-122, the third device 130 and the fourth device 140.

In the process 300, the first device 110 can communication with the second devices 120 and 122 (not shown for brevity) in either unicast mode or in groupcast mode. In addition, HARQ feedback based sidelink retransmission is implemented.

The first device 110 may evaluate 305 reception status of a plurality of transmissions previously transmitted to the second devices 120 and 122. The plurality of transmissions may be various sidelink transmissions, including but not limited to, initial transmissions of transport blocks (TBs), retransmissions of the TBs, initial transmissions of periodic traffic, initial transmissions of aperiodic traffic and so on.

In order to obtain sufficient reception status for evaluation, the first device 110 may collect HARQ-ACK/NACK feedbacks for sidelink transmissions during a certain period of time or accumulate HARQ-ACK/NACK feedbacks for a certain number of sidelink transmissions.

For example, the first device 110 may evaluate the HARQ-ACK/NACK feedbacks for the sidelink transmissions within a certain time window, for example, a SL mode 2 sensing window or a back-off time corresponding to the current CWS value. Additionally, or alternatively, the first device 110 may evaluate the HARQ-ACK/NACK feedbacks for a number of previous SL transmissions, and the number may be (pre-) configured at the first device 110.

The first device 110 may access 310 the sidelink channel by performing the LBT procedure based on the current CWS, i.e., a first CWS.

The first device 110 transmits 315, to the second device 120, a target transmission via the sidelink channels, such as, PSCCH and PSSCH.

However, the decoding of the target transmission is failed 320 at the second device 120. Accordingly, the second device 120 transmits 325 HARQ-NACK feedback for the target transmission to the first device 110.

Upon receipt of the HARQ-NACK feedback for the target transmission, the first device 110 determines 330 a second CWS to be used for the CW based on the evaluation on HARQ-ACK/NACK feedbacks for previous sidelink transmissions at 305. It should be understood that although in FIG. 3, the evaluation is shown to be made at the beginning of the process 300, it may also be made in a flexible manner. For example, in some other example embodiments, the first device 110 may evaluate the reception status of previous sidelink transmissions between the steps 310 and 315, between the steps 315 and 320, between the steps 320 and 325, or otherwise between the steps 325 to 330.

As mentioned above, the SL Tx UE may indicate the reserved resources for SL retransmissions in the first stage SCI of SL initial transmission. The indicated resources for SL retransmissions may be sensed by other SL UEs in proximity. Thus, the other SL UEs will avoid selecting the same resources in SL RA mode 2, which in turn leads to a lower intra-system collision rate for SL retransmissions than the SL initial transmission. In contrast, the inter-system collision rate is not expected to be quite different between the SL initial transmission and the SL retransmission, since the non-SL devices (e.g., the fourth device 140) are unable to decode the SCIs. In this case, evaluation on the HARQ-ACK and HARQ-NACK for SL initial transmission and retransmission can be used to detect if a SL transmission failure is caused due to collisions within the SL-U system or due to collisions from other unlicensed band users.

In some example embodiments, the first device 110 may evaluate the HARQ-ACK/NACK feedbacks for at least one initial transmission via the sidelink channel and the HARQ-ACK/NACK feedbacks for at least one retransmission. For example, the first device 110 may determine a first ratio associated with HARQ-ACK feedbacks and HARQ-NACK feedbacks for at least one initial transmission. Similarly, the first device 110 may determine a second ratio associated with HARQ-ACK feedbacks and HARQ-NACK feedbacks for at least one retransmission. The first device 110 may then determine a variation from the first ratio to the second ratio. In this case, the ACK or NACK feedbacks from different SL groupcast Rx UEs, i.e., the second devices 120 and 122, are used to evaluate the reception status for SL initial transmission and retransmission.

For instance, if SL transmission failure is mainly caused by the collision from other unlicensed band users (i.e., inter-system collisions) rather than the collision from other SL-U users (i.e., intra-system collisions), the ratios of HARQ-ACK/NACK feedbacks for SL initial transmission and retransmission may be the same or similar. In this case, the size of the CW may be increased in response to the HARQ-NACK received at 325. That is, the value of the second CWS may be determined to be a next higher CWS value as compared with the value of the first CWS. Note that, in the case where the transmission failure is due to inter-system collisions, it is also expected that the non-SL devices, i.e., the fourth device 140, will also apply CWS adjustment.

However, if the variation of the ratios of HARQ-ACK/NACK feedbacks for SL initial transmission and retransmission is relatively large, for example, larger than a variation threshold (pre-) configured at the first device 110, the size of the CW may be maintained unchanged or decreased even when HARQ-NACK feedback is received. In this case, the value of the second CWS is less than or equal to the value of the first CWS.

In some example embodiments where soft combining is used for SL retransmissions, the transmission failure will be alleviated even for the case where the inter-system collisions are the main reason for transmission failure. Thus, more than one variation thresholds may be taken into account when evaluating the ratios of HARQ-ACK/NACK feedbacks for SL initial transmission and retransmission depending on whether soft combining is configured or not. If soft combining is not configured, a lower variation threshold may be used to determine the second CWS as described above. When soft combining is configured, a higher variation threshold may be used to determine the second CWS as soft combining itself impacts the ratio associated with HARQ-ACK feedbacks and HARQ-NACK feedback for the initial transmission and retransmission.

In some example embodiments, the first and second ratios may be respective ratios of the HARQ-ACK feedbacks to the HARQ-NACK feedbacks. In some other example embodiments, the first and second ratios may be respective ratios of the HARQ-NACK feedbacks to the HARQ-ACK feedbacks.

Additionally, or alternatively, the SL Tx UE may indicate the reserved resources for upcoming periodic SL transmissions in the first stage SCI of an early SL transmission. The indicated resources for upcoming periodic SL transmission may be sensed by other SL UEs in proximity. Thus, the other SL UEs will avoid selecting the same resources in SL RA mode 2, which in turn leads to a lower intra-system collision rate for upcoming periodic SL transmission. However, for aperiodic traffic, no resource reservation indication for upcoming new SL transmissions is provided in the SCI. In this case, evaluation on the HARQ-ACK and HARQ-NACK for SL initial transmission of periodic traffic and aperiodic traffic can be used to detect if a SL transmission failure is caused due to collisions within the SL-U system or due to collisions from other unlicensed band users.

For example, a third ratio associated with the HARQ-ACK and HARQ-NACK feedbacks for SL initial transmissions for periodic traffic and a fourth ratio associated with the HARQ-ACK and HARQ-NACK feedbacks for SL initial transmissions for aperiodic traffic may be different, if the SL transmission failure is mainly caused by intra-system collisions. In this case, the size of the CW may be maintained unchanged or decreased even when HARQ-NACK feedback is received. Thus, the value of the second CWS is less than or equal to the value of the first CWS.

On the other hand, a third ratio associated with the HARQ-ACK and HARQ-NACK feedbacks for SL initial transmissions for periodic traffic and a fourth ratio associated with the HARQ-ACK and HARQ-NACK feedbacks for SL initial transmissions for aperiodic traffic may be the same or similar, if the SL transmission failure is mainly caused by inter-system collision. Thus, when HARQ-NACK is received by the SL Tx UE, the size of the CW may be increased in response to the HARQ-NACK received at 325. For example, the value of the second CWS may be determined to be a next higher CWS value as compared with the value of the first CWS.

In some example embodiments, the third and fourth ratios may be respective ratios of the HARQ-ACK feedbacks to the HARQ-NACK feedbacks. In some other example embodiments, the third and fourth ratios may be respective ratios of the HARQ-NACK feedbacks to the HARQ-ACK feedbacks.

In some embodiments of discontinuous transmission (DTX) feedback (i.e., neither HARQ-ACK nor HARQ-NACK would be fed back from SL Rx UEs) may be taken either as the HARQ-NACK feedback, or alternatively, the DTX feedback may be configured with a weight factor used for being counted as the HARQ-NACK feedback. For the latter case, the weight factor of the DTX feedback may be selected from 0.5 and 1.5, which means that one DTX may be counted as half of HARQ-NACK with the weight factor of 0.5, or as one half of HARQ-NACK with the weight factor of 1.5.

The first device 110 may select the weight factor to be used from a group of candidate weight factors. In some example embodiments, the group of candidate weight factors, for example, 0.5 and 1.5 and/or corresponding conditions of using each weight factor may be (pre-) configured at the first device 110 or specified in relevant standards. In some example embodiments, the weight factor may be selected based on a (pre-) configured rule associated with a reference signal received via the sidelink channel. For example, the rule may be associated with a measurement parameter of the reference signal, such as, SL RSRP. The first device 110 may monitor the SL RSRP, and if the SL RSRP exceeds a parameter threshold, the first device 110 may select a first weight factor (e.g., 0.5) from the group of candidate weight factors. Otherwise, if the SL RSRP does not exceed the parameter threshold, the first device 110 may select a second weight factor (e.g., 1.5) from the group of candidate weight factors. In this case, any of the measurement parameter, the rule associated with a reference signal and the parameter threshold can be either (pre-) configured at the first device 110 or specified in relevant standards. The present application is not limited in this aspect.

In some embodiments, the CWS adjustment mechanism may not be applied for all the HARQ-NACKs of every SL transmission or re-transmission. For instance, only the HARQ-NACK corresponding to the first SL transmission within the COT may trigger the adjustment of the CWS. The HARQ feedback of following SL transmissions, either initial transmission or retransmission, within the COT may not trigger the adjustment of the CWS. Alternatively, only the HARQ-NACK corresponding to the last SL retransmissions of a TB (e.g., failure of TB delivery) may trigger the adjustment of the CWS, other than the HARQ-NACK corresponding to any SL initial transmission or SL retransmissions before the last SL retransmission.

According to the example embodiments, there is provided an enhanced mechanism for CWS adjustment. Based on the enhanced mechanism, the sidelink UE takes both of intra-SL system collisions and inter-system collisions into consideration when determining the CWS. As such, the CWS is adjusted based on not only the detection of transmission failure via sidelink, but also the evaluation of ACK/NACK feedbacks for various sidelink transmissions.

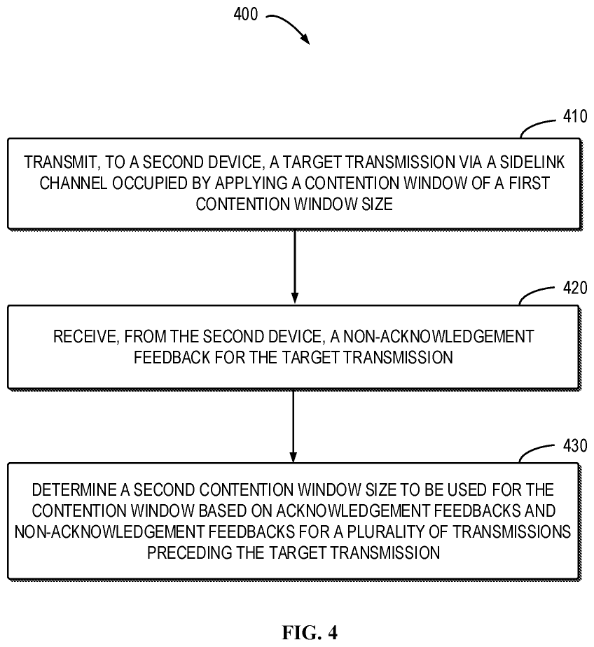

FIG. 4 illustrates a flowchart of an example method 400 implemented at a terminal device. The method 400 can be implemented by a terminal device that takes a role of initiating device or a transmitting UE, for example, the first device 110 shown in FIG. 1. For the purpose of discussion, the method 400 will be described with reference to FIG. 1. It is to be understood that method 400 may further include additional blocks not shown and/or omit some shown blocks, and the scope of the present disclosure is not limited in this regard.

At 410, the first device 110 transmits, to a second device 120, a target transmission via a sidelink channel occupied by applying a CW of a first CWS.

At 420, the first device 110 receives, from the second device 120, a non-acknowledgement feedback for the target transmission. The non-acknowledgement feedback may be, for example, the HARQ-NACK feedback.

At 430, the first device 110 determines a second CWS to be used for the CW based on acknowledgement feedbacks and non-acknowledgement feedbacks for a plurality of transmissions preceding the target transmission. The plurality of transmissions may include, but not limited to, initial transmissions/retransmissions, initial transmissions of periodic traffic, initial transmissions of aperiodic traffic, and so on.

The second CWS may be determined based on ratio parameters associated with HARQ feedbacks for initial transmissions and retransmissions. In some example embodiments, the first device 110 may determine a first ratio associated with acknowledgement feedbacks and non-acknowledgement feedbacks for at least one initial transmission via the sidelink channel. The first device 110 may determine a second ratio associated with acknowledgement feedbacks and non-acknowledgement feedbacks for at least one retransmission via the sidelink channel. The first device 110 may then determine the second CWS based on a variation from the first ratio to the second ratio.

The plurality of transmissions preceding the target transmission may be transmitted in a groupcast mode via the sidelink channel, and in this case, the acknowledgement feedbacks and the non-acknowledgement feedbacks may be received from a group of devices associated with the groupcast mode. For example, the group of devices may be the second devices 120 and 122.

In some example embodiments, the first device 110 may determine a third ratio associated with acknowledgement feedbacks and non-acknowledgement feedbacks for at least one initial transmission for periodic traffic of the first device 110. The first device 110 may determine a fourth ratio associated with acknowledgement feedbacks and non-acknowledgement feedbacks for at least one initial transmission for an aperiodic traffic of the first device 110. Similarly, the first device 110 may then determine the second CWS based on a variation from the third ratio to the fourth ratio.

In some example embodiments, if the variation exceeds the variation threshold, the first device 110 may determine that the non-acknowledgement feedback for the target transmission is caused by a collision with at least one third device operating on the sidelink channel in unlicensed band, e.g., the third device 130. That is, the sidelink transmission failure is mainly due to intra-system collisions. Otherwise, if the variation does not exceed the variation threshold, the first device 110 may determine that the non-acknowledgement feedback for the target transmission is caused by a collision with at least one fourth device operating on a channel in unlicensed band other than the sidelink channel, e.g., the four device 140. In this case, the sidelink transmission failure is mainly due to inter-system collisions.

In the above embodiments, the first device 110 may compare the variation with a variation threshold that may be (pre-) configured at the first device 110. If the variation exceeds a variation threshold, the first device 110 may determine the second CWS to be no greater than the first CWS. For example, the second CWS may be less than the first CWS. For another example, the second CWS may be equal to the first CWS, that is, the duration of the CW remains unchanged. Otherwise, if the variation does not exceed the variation threshold, the first device 110 may determine the second CWS to be greater than the first CWS. For example, the second CWS may be set to the next higher allowed value of the CW.

The variation threshold may be selected from a group of candidate thresholds. In some example embodiments, if the plurality of transmissions preceding the target transmission is received based on soft combining, the first device 110 may select, from the group of candidate thresholds, a first variation threshold for evaluating the variation. Otherwise, if the plurality of transmissions preceding the target transmission is not received based on soft combining, the first device 110 may select a second variation threshold from the group of candidate thresholds, and the second variation threshold is different from the first variation threshold.

In some example embodiments, the first ratio and the second ratio may comprise respective ratios of the acknowledgement feedbacks to the non-acknowledgement feedbacks For example, the first ratio may be a ratio of ACK/NACK feedbacks for the initial transmissions, while the second ratio may be a ratio of ACK/NACK feedbacks for the retransmissions.

In some example embodiments, the first ratio and the second ratio may comprise respective ratios of the non-acknowledgement feedbacks to the acknowledgement feedbacks. For example, the first ratio may be a ratio of NACK/ACK feedbacks for the initial transmissions while the second ratio may be a ratio of NACK/ACK feedbacks for the retransmissions.

In some example embodiments, the third ratio and the fourth ratio may comprise respective ratios of the acknowledgement feedbacks to the non-acknowledgement feedbacks For example, the third ratio may be a ratio of ACK/NACK feedbacks for the initial transmissions of periodic traffic, while the fourth ratio may be a ratio of ACK/NACK feedbacks for the initial transmissions of aperiodic traffic.

In some example embodiments, the third ratio and the fourth ratio may comprise respective ratios of the non-acknowledgement feedbacks to the acknowledgement feedbacks. For example, the third ratio may be a ratio of NACK/ACK feedbacks for the initial transmissions of periodic traffic, while the fourth ratio may be a ratio of NACK/ACK feedbacks for the initial transmissions of aperiodic traffic.

In some example embodiments, the plurality of transmissions preceding the target transmission may be performed within a target period of time associated with one of a sensing window configured for the first device 110, and a back-off time corresponding to the first CWS. Additionally, or alternatively, the plurality of transmissions preceding the target transmission may comprise a predetermined number of previous transmissions. The number of previous transmissions may be preconfigured at the first device 110 or specified in relevant standards. The present application is not limited in this aspect.

The non-acknowledgement feedbacks for the plurality of transmissions may comprise at least one discontinuous transmission, DTX, feedback, and the number of the at least one DTX feedback may be determined based on a weight factor. In some example embodiments, a group of candidate weight factors is (pre-) configured at the first device 110, and the first device 110 may select, from the group of candidate weight factors, the weight factor based on a (pre-) configured rule associated with a reference signal received via the sidelink channel.

In some example embodiments, to select the weight factor, the first device may determine a measurement parameter of the reference signal. If the measurement parameter of the reference signal exceeds a parameter threshold, the first device 110 may select a first weight factor from the group of candidate weight factors. If the measurement parameter of the reference signal does not exceed the parameter threshold, the first device 110 may select a second weight factor from the group of candidate weight factors, and the second weight factor is different from the first weight factor.

By way of example, the measurement parameter of the reference signal may be a RSRP monitored on the sidelink channel. In a case where the RSRP is not higher than a (pre-) configured threshold, the first device 110 may choose the first weight factor. In a case where the RSRP is higher than the (pre-) configured threshold, the first device 110 may choose the second weight factor. It should be understood that RSRP is given for illustrative purpose without limitation, and any other measurement parameters are also possible.

In some example embodiments of unicast transmissions, the target transmission may comprise at least one transmission performed within a COT acquired by applying the contention window of the first CWS.

In some example embodiments, the first device 110 may be a first terminal device, and the second device 120 may be a second terminal device.

In some example embodiments, a first apparatus capable of performing any of the method 400 (for example, the first device 110) may comprise means for performing the respective steps of the method 400. The means may be implemented in any suitable form. For example, the means may be implemented in a circuitry or software module.

In some example embodiments, the first apparatus comprises: means for transmitting, to a second apparatus, a target transmission via a sidelink channel occupied by applying a contention window of a first contention window size, CWS; means for receiving, from the second apparatus, a non-acknowledgement feedback for the target transmission; and means for determining a second CWS to be used for the contention window based on acknowledgement feedbacks and non-acknowledgement feedbacks for a plurality of transmissions preceding the target transmission.

In some example embodiments, the means for determining the second CWS comprises: means for determining a first ratio associated with acknowledgement feedbacks and non-acknowledgement feedbacks for at least one initial transmission for a transport block via the sidelink channel; means for determining a second ratio associated with acknowledgement feedbacks and non-acknowledgement feedbacks for at least one retransmission for the transport block via the sidelink channel; and means for determining the second CWS based on a variation from the first ratio to the second ratio.

In some example embodiments, the plurality of transmissions preceding the target transmission is transmitted in a groupcast mode via the sidelink channel, and the acknowledgement feedbacks and the non-acknowledgement feedbacks are received from a group of devices associated with the groupcast mode.

In some example embodiments, the means for determining the second CWS comprises: means for determining a third ratio associated with acknowledgement feedbacks and non-acknowledgement feedbacks for at least one initial transmission for a periodic traffic of the first apparatus; means for determining a fourth ratio associated with acknowledgement feedbacks and non-acknowledgement feedbacks for at least one initial transmission for an aperiodic traffic of the first apparatus; and means for determining the second CWS based on a variation from the third ratio to the fourth ratio.

In some example embodiments, the means for determining the second CWS comprises: means for in accordance with a determination that the variation exceeds a variation threshold, determining the second CWS to be no greater than the first CWS; and means for in accordance with a determination that the variation is not exceeding the variation threshold, determining the second CWS to be greater than the first CWS.

In some example embodiments, the first apparatus further comprises: means for in accordance with a determination that the plurality of transmissions preceding the target transmission is received based on soft combining, select, from a group of candidate thresholds, a first variation threshold for evaluating the variation; and means for in accordance with a determination that the plurality of transmissions preceding the target transmission is not received based on soft combining, select, from the group of candidate thresholds, a second variation threshold different from the first variation threshold.

In some example embodiments, the first apparatus further comprises: means for in accordance with a determination that the variation exceeds the variation threshold, determining the non-acknowledgement feedback for the target transmission being caused by a collision with at least one third apparatus operating on the sidelink channel in unlicensed band; and means for in accordance with a determination that the variation is not exceeding the variation threshold, determining the non-acknowledgement feedback for the target transmission being caused by a collision with at least one fourth apparatus operating on a channel in unlicensed band other than the sidelink channel.

In some example embodiments, the first ratio and the second ratio comprise respective ratios of the acknowledgement feedbacks to the non-acknowledgement feedbacks.

In some example embodiments, the first ratio and the second ratio comprise respective ratios of the non-acknowledgement feedbacks to the acknowledgement feedbacks.

In some example embodiments, the third ratio and the fourth ratio comprise respective ratios of the acknowledgement feedbacks to the non-acknowledgement feedbacks.

In some example embodiments, the third ratio and the fourth ratio comprise respective ratios of the non-acknowledgement feedbacks to the acknowledgement feedbacks.

In some example embodiments, the plurality of transmissions preceding the target transmission are performed within a target period of time associated with one of a sensing window configured for the first apparatus, and a back-off time corresponding to the first CWS.

In some example embodiments, the plurality of transmissions preceding the target transmission comprises a predetermined number of previous transmissions.

In some example embodiments, the non-acknowledgement feedbacks for the plurality of transmissions comprise at least one discontinuous transmission, DTX, feedback, and the number of the at least one DTX feedback is determined based on a weight factor.

In some example embodiments, the first apparatus further comprises: means for selecting, from a group of candidate weight factors, the weight factor based on a preconfigured rule associated with a reference signal received via the sidelink channel.

In some example embodiments, the means for selecting the weight factor comprises: means for in accordance with a determination that a measurement parameter of the reference signal exceeds a parameter threshold, selecting a first weight factor from the group of candidate weight factors; and means for in accordance with a determination that the measurement parameter of the reference signal is not exceeding the parameter threshold, selecting a second weight factor from the group of candidate weight factors, the second weight factor being different from the first weight factor.

In some example embodiments, the target transmission comprises at least one transmission performed within a channel occupancy time, COT, acquired by applying the contention window of the first CWS.

In some example embodiments, the first apparatus comprises a first terminal device, and a second apparatus comprises a second terminal device.

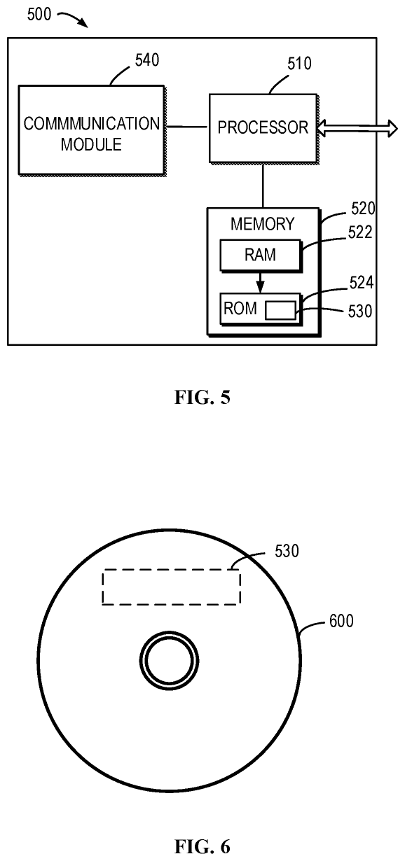

FIG. 5 is a simplified block diagram of a device 500 that is suitable for implementing embodiments of the present disclosure. The device 500 may be provided to implement the communication device, for example the first device 110, the second devices 120 and 122, and the third device 130 as shown in FIG. 1. As shown, the device 500 includes one or more processors 510, one or more memories 520 coupled to the processor 510, and one or more transmitters and/or receivers (TX/RX) 540 coupled to the processor 510.

The TX/RX 540 may be configured for bidirectional communications. The TX/RX 540 has at least one antenna to facilitate communication. The communication interface may represent any interface that is necessary for communication with other network elements.

The processor 510 may be of any type suitable to the local technical network and may include one or more of the following: general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

The memory 520 may include one or more non-volatile memories and one or more volatile memories. Examples of the non-volatile memories include, but are not limited to, a Read Only Memory (ROM) 524, an electrically programmable read only memory (EPROM), a flash memory, a hard disk, a compact disc (CD), a digital video disk (DVD), and other magnetic storage and/or optical storage media. Examples of the volatile memories include, but are not limited to, a random access memory (RAM) 522 and other volatile memories that will not last in the power-down duration.

A computer program 530 includes computer executable instructions that may be executed by the associated processor 510. The program 530 may be stored in the ROM 524. The processor 510 may perform any suitable actions and processing by loading the program 530 into the RAM 522.

The embodiments of the present disclosure may be implemented by means of the program 530 so that the device 500 may perform any process of the disclosure as discussed with reference to FIG. 3. The embodiments of the present disclosure may also be implemented by hardware or by a combination of software and hardware.

In some embodiments, the program 530 may be tangibly contained in a computer readable medium which may be included in the device 500 (such as in the memory 520) or other storage devices that are accessible by the device 500. The device 500 may load the program 530 from the computer readable medium to the RAM 522 for execution. The computer readable medium may include any types of tangible non-volatile storage, such as ROM, EPROM, a flash memory, a hard disk, CD, DVD, and the like. FIG. 6 shows an example of the computer readable medium 600 in form of CD or DVD. The computer readable medium has the program 530 stored thereon.

Various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations. It is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 400 as described above with reference to FIG. 4. Generally, program modules may include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-21. (canceled)

22. A first device, comprising:
at least one processor; and
at least one memory including computer program codes;
the at least one memory and the computer program codes are configured to, with the at least one processor, cause the first device at least to:
transmit, to a second device, a target transmission via a sidelink channel occupied by applying a contention window of a first contention window size, CWS;
receive, from the second device, a non-acknowledgement feedback for the target transmission; and
determine a second CWS to be used for the contention window based on acknowledgement feedbacks and non-acknowledgement feedbacks for a plurality of transmissions preceding the target transmission.

23. The first device of claim 22, wherein the second CWS is determined by:
determining a first ratio associated with acknowledgement feedbacks and non-acknowledgement feedbacks for at least one initial transmission for a transport block via the sidelink channel;
determining a second ratio associated with acknowledgement feedbacks and non-acknowledgement feedbacks for at least one retransmission for the transport block via the sidelink channel; and
determining the second CWS based on a variation from the first ratio to the second ratio.

24. The first device of claim 23, wherein the plurality of transmissions preceding the target transmission is transmitted in a groupcast mode via the sidelink channel, and the acknowledgement feedbacks and the non-acknowledgement feedbacks are received from a group of devices associated with the groupcast mode.

25. The first device of claim 22, wherein the second CWS is determined by:
determining a third ratio associated with acknowledgement feedbacks and non-acknowledgement feedbacks for at least one initial transmission for a periodic traffic of the first device;
determining a fourth ratio associated with acknowledgement feedbacks and non-acknowledgement feedbacks for at least one initial transmission for an aperiodic traffic of the first device; and
determining the second CWS based on a variation from the third ratio to the fourth ratio.

26. The first device of claim 23, wherein the second CWS is determined by:
in accordance with a determination that the variation exceeds a variation threshold, determining the second CWS to be no greater than the first CWS; and
in accordance with a determination that the variation is not exceeding the variation threshold, determining the second CWS to be greater than the first CWS.

27. The first device of claim 26, wherein the at least one memory and the computer program codes are configured to, with the at least one processor, further cause the first device to:
in accordance with a determination that the plurality of transmissions preceding the target transmission is received based on soft combining, select, from a group of candidate thresholds, a first variation threshold for evaluating the variation; and
in accordance with a determination that the plurality of transmissions preceding the target transmission is not received based on soft combining, select, from the group of candidate thresholds, a second variation threshold different from the first variation threshold.

28. The first device of claim 23, wherein the at least one memory and the computer program codes are configured to, with the at least one processor, further cause the first device to:
in accordance with a determination that the variation exceeds the variation threshold, determine the non-acknowledgement feedback for the target transmission being caused by a collision with at least one third device operating on the sidelink channel in unlicensed band; and
in accordance with a determination that the variation is not exceeding the variation threshold, determine the non-acknowledgement feedback for the target transmission being caused by a collision with at least one fourth device operating on a channel in unlicensed band other than the sidelink channel.

29. The first device of claim 23, wherein the first ratio and the second ratio comprise respective ratios of the acknowledgement feedbacks to the non-acknowledgement feedbacks.

30. The first device of claim 23, wherein the first ratio and the second ratio comprise respective ratios of the non-acknowledgement feedbacks to the acknowledgement feedbacks.

31. The first device of claim 25, wherein the third ratio and the fourth ratio comprise respective ratios of the acknowledgement feedbacks to the non-acknowledgement feedbacks.

32. The first device of claim 25, wherein the third ratio and the fourth ratio comprise respective ratios of the non-acknowledgement feedbacks to the acknowledgement feedbacks.

33. The first device of claim 22, wherein the plurality of transmissions preceding the target transmission are performed within a target period of time associated with one of a sensing window configured for the first device, and a back-off time corresponding to the first CWS.

34. The first device of claim 22 wherein the plurality of transmissions preceding the target transmission comprises a predetermined number of previous transmissions.

35. The first device of claim 22, wherein the non-acknowledgement feedbacks for the plurality of transmissions comprise at least one discontinuous transmission, DTX, feedback, and the number of the at least one DTX feedback is determined based on a weight factor.

36. The first device of claim 35, wherein the at least one memory and the computer program codes are configured to, with the at least one processor, further cause the first device to:
select, from a group of candidate weight factors, the weight factor based on a preconfigured rule associated with a reference signal received via the sidelink channel.

37. The first device of claim 36, wherein the weight factor is selected by:
in accordance with a determination that a measurement parameter of the reference signal exceeds a parameter threshold, selecting a first weight factor from the group of candidate weight factors; and
in accordance with a determination that the measurement parameter of the reference signal is not exceeding the parameter threshold, selecting a second weight factor from the group of candidate weight factors, the second weight factor being different from the first weight factor.

38. The first device of claim 22, wherein the target transmission comprises at least one transmission performed within a channel occupancy time, COT, acquired by applying the contention window of the first CWS.

39. The first device of claim 22, wherein the first device comprises a first terminal device, and a second device comprises a second terminal device.

40. A method comprising:
transmitting, at a first device and to a second device, a target transmission via a sidelink channel occupied by applying a contention window of a first contention window size, CWS;
receiving, from the second device, a non-acknowledgement feedback for the target transmission; and
determining a second CWS to be used for the contention window based on acknowledgement feedbacks and non-acknowledgement feedbacks for a plurality of transmissions preceding the target transmission.

41. A non-transitory computer readable medium comprising program instructions that, when executed by an apparatus, cause the apparatus to perform
transmitting, at a first device and to a second device, a target transmission via a sidelink channel occupied by applying a contention window of a first contention window size, CWS;
receiving, from the second device, a non-acknowledgement feedback for the target transmission; and
determining a second CWS to be used for the contention window based on acknowledgement feedbacks and non-acknowledgement feedbacks for a plurality of transmissions preceding the target transmission.
